(19) United States
(12) Patent Application Publication
(10) Pub. No.: US 2011/0101293 A1
(43) Pub. Date: May 5, 2011

(54) Workhorse Winch

(75) Inventor: James Kempf, Wallkill, NY (US)

(73) Assignee: PRODUCTION RESOURCE GROUP L.L.C., New Windsor, NY (US)

(21) Appl. No.: 12/912,532

(22) Filed: Oct. 26, 2010

Related U.S. Application Data
(60) Provisional application No. 61/256,587, filed on Oct. 30, 2009.

(51) Int. Cl. B66D 1/20; F16H 7/00; F16H 7/06

(52) U.S. Cl. 254/358; 474/148; 474/101

(57) ABSTRACT

A winch driven by a rotatable cassette. The cassette can be rotated into multiple different positions. Each of the addition positions produces a different speed up the output for a cable.

This application claims priority from provisional application No. 61/256,587, filed Oct. 30, 2009, the entire contents of which are herewith incorporated by reference.

### BACKGROUND

Winches can be used to move various objects and scenery, especially in a stage environment.

When used in a stage environment, the conditions of the stage may dictate the conditions under which the device can be used. Therefore, it can be useful to have a device which can be easily configured between different speeds and forms of operation.

### SUMMARY

An embodiment describes a reconfigurable winch which has a number of different features.

One embodiment uses a reconfigurable or replaceable drive cassette which has different characteristics.

### BRIEF DESCRIPTION OF THE DRAWINGS

FIG. 1 shows a front on view of the winch;

FIGS. 2A and 2B show respectively side and top views of the winch showing the different parts within the winch;

FIGS. 3A-4D show the different winch configurations.

FIG. 5A-5C shows a close-up detail of the chain driving cassette.

### DETAILED DESCRIPTION

The “workhouse” deck winch as described herein has aspects making it operational specifically for the live entertainment “Broadway” market. This winch has a unique feature of a configurable chain cassette transmission that allows multiple different speeds and, e.g., seven varied speeds and line pulls to be changed quickly in the field.

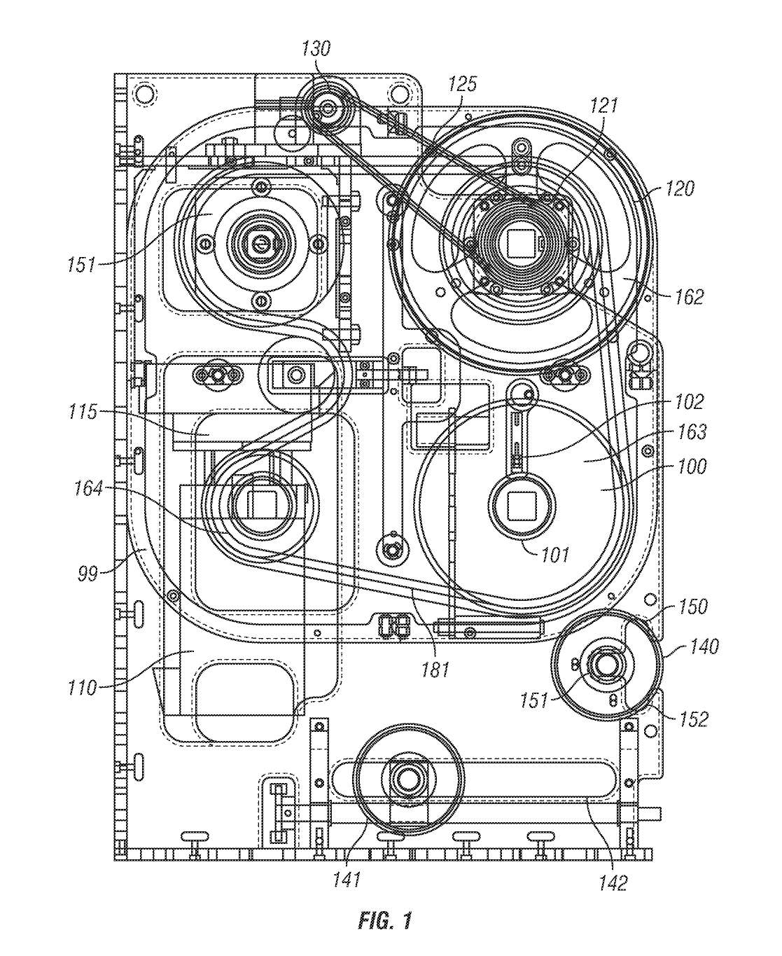

In FIG. 1, a removable cassette 99 is provided. More generally, the cassette can be any kind of configurable device with multiple different movable items, that are connected rotatably together, and where any of those movable items can be driven and any of those movable items can drive a load. Here the load is the cable holder. In this embodiment, the cassette is chain driven, with four different rotational roller chain sprockets 161, 162, 163 and 164, and with a roller chain 181 extending between the roller chain sprockets. Rotating any of the roller chain sprockets causes the others to rotate through the action of the roller chain that is coupled therebetween.

Each of the four different movable items, here sprockets for the chain, has a different radius. The radius of the sprocket 164 is smaller than the radius of the sprocket 161 which is smaller than sprocket 163 which is correspondingly smaller than sprocket 162. Each of the movable items has a same format connection, here shown as a square that mates with a square shank. In the embodiment, the motor/gear assembly has an output piece that is a square shank, and the cable spool 100 also has a square shank, so that any of the items can mate with any of the spockets.

A motor brake can also mate with the shanks, allowing a braking function.

The cassette is also movable into a number of different positions. The cassette has four “edges”; any of which can be attached to the motor and drive assembly to receive rotational force therefrom. For example, in the configuration shown in FIG. 1, the sprocket 164 receives the rotational force. However, the cassette can be rotated counterclockwise by 90° in order to place the sprocket 161 in the location where it receives the rotational force. The cassette 99 also has two different sides which can be differently geared. By removing the cassette and rotating it (90/180/270) and rotating it to the two different sides, the speed and hence line pull of the winch can be changed through these different sprocket combinations.

There are eight possible positions for the cassette, but one repeat due to the one-to-one chain drive, so there are seven possible speed and pull combinations.

The cable itself which can be extended and retracted is held on a cable spool 100 that is coupled to the sprocket 163. A cable keeper 102 provides a variable amount of pressure against the cable 101 that is wound on the cable spool 100. A motor 110 is connected to a gearbox 115 which may be a 44.5 to 1 gearbox that provides driving power to the cassette 99.

The sprocket 162 is connected to the shaft 120 that itself is connected via a belt 125 to a feedback subassembly roller 130 that monitors the amount of movement of the chain 181.

The winch includes one tensioning sheave 141, and a reconfigurable outrigger sheave subassembly 140.

The outrigger sheave subassembly includes three different locations where the sheave can be located. This includes an upper location 150, a lower location 152 which is directly opposite to the upper location and can hold a second sheave beyond the one in the upper location, and a central rear location 151.

The tensioner sheave is mounted on one or more Acme screws shown as 142 that control the speed and operation of tensioning. The Acme screws are connected to rotate in synchronism with the driving of the cable device. The Acme screws operate to move the tensioner sheave by an amount that is synchronized to the degree of payout of the cable off of the cable holder 100. As more cable pays off of the cable holder 100, the tensioner sheave appropriately moves to compensate for the different location of the cable payout. The sheaves on the acme screw thus become walking sheaves which move in synchronism with the amount of payout of the cable.

Note that all of the motor 110, the cable cassette 100, and the drum 120 include substantially square slots such as 121 at a location of an axis of rotation. This allows connecting these two corresponding slots to the motor so that any of these can become the driven sprocket, as described herein.

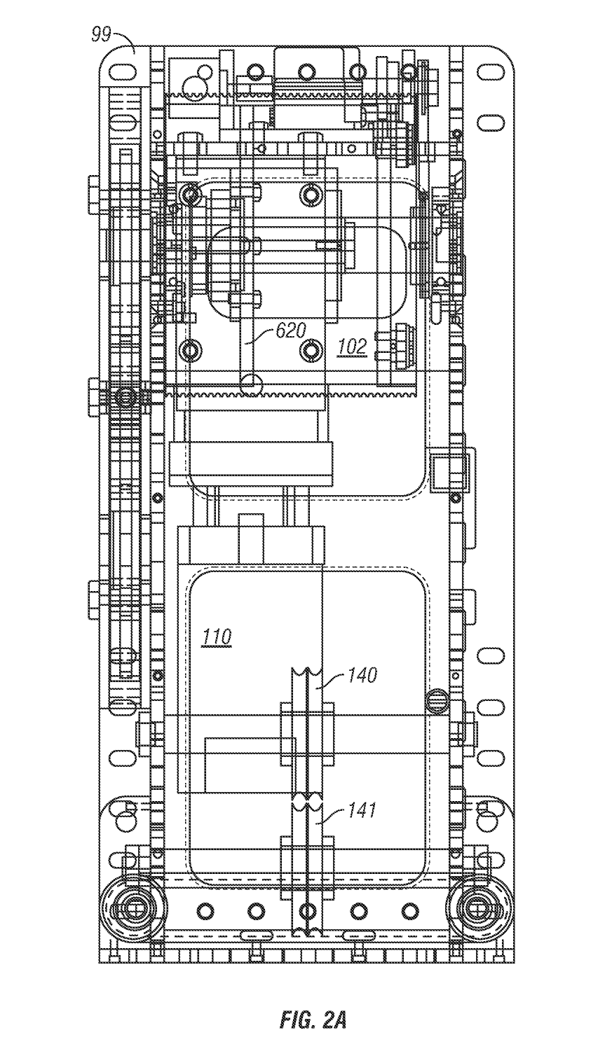

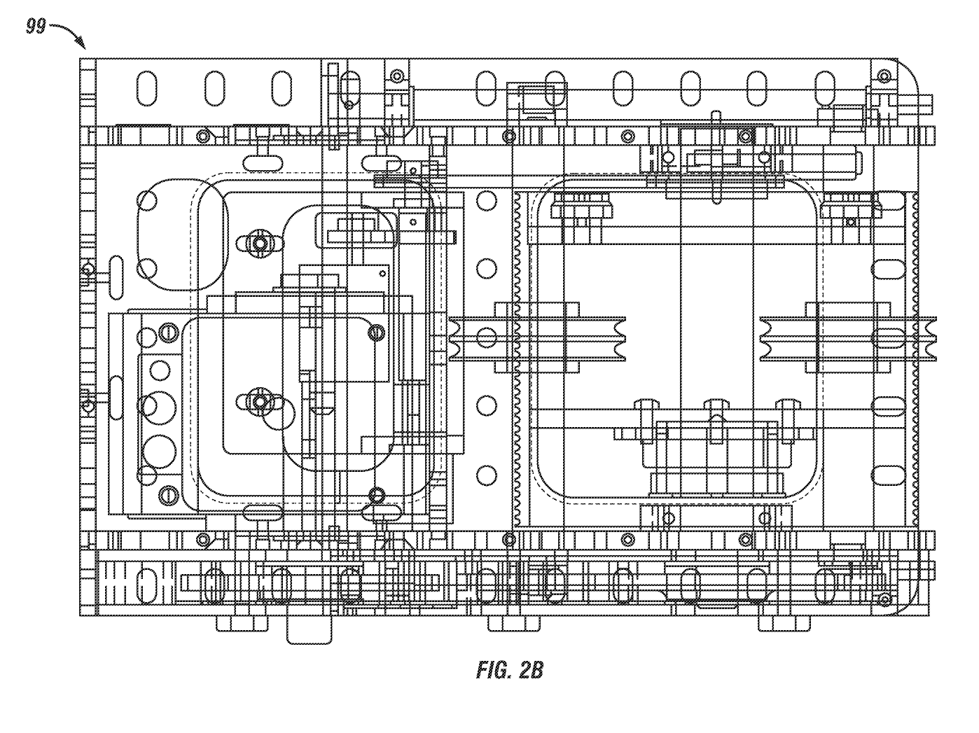

FIG. 2A illustrates a side view of the unit, from the left side as shown in FIG. 1. Note that this shows the motor and the different sheaves 140, 141 along a central axis of the housing of the winch. The cassette 99 is in the very front of the winch, connected to the motor and gear assembly, and also connected to the drum 120 and cable keeper 100. FIG. 2B shows a view from the top, also showing all of these parts.

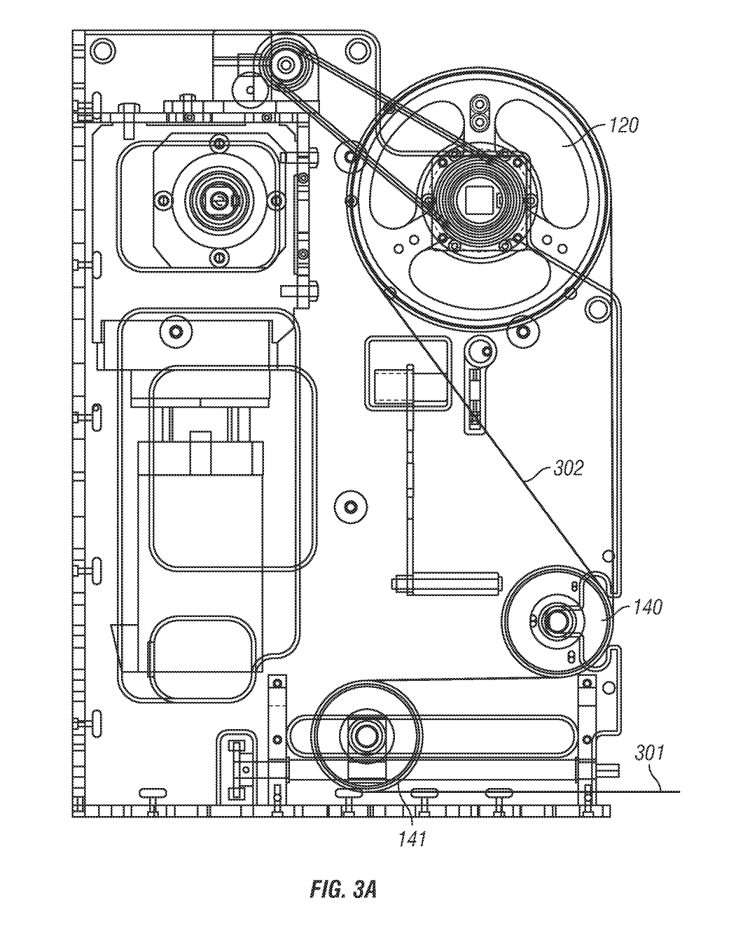

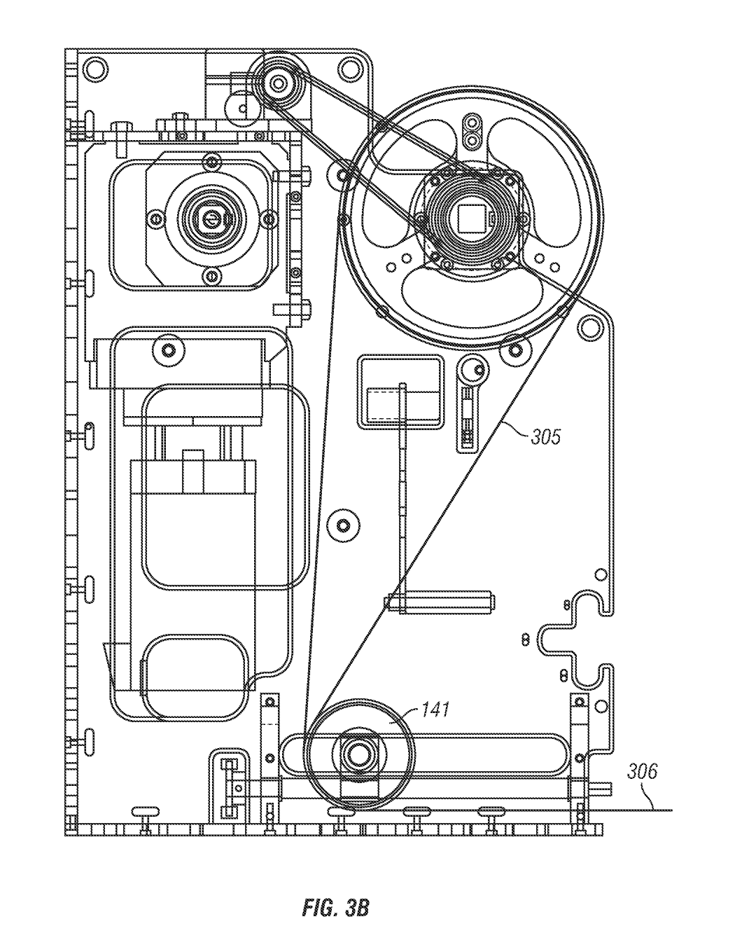

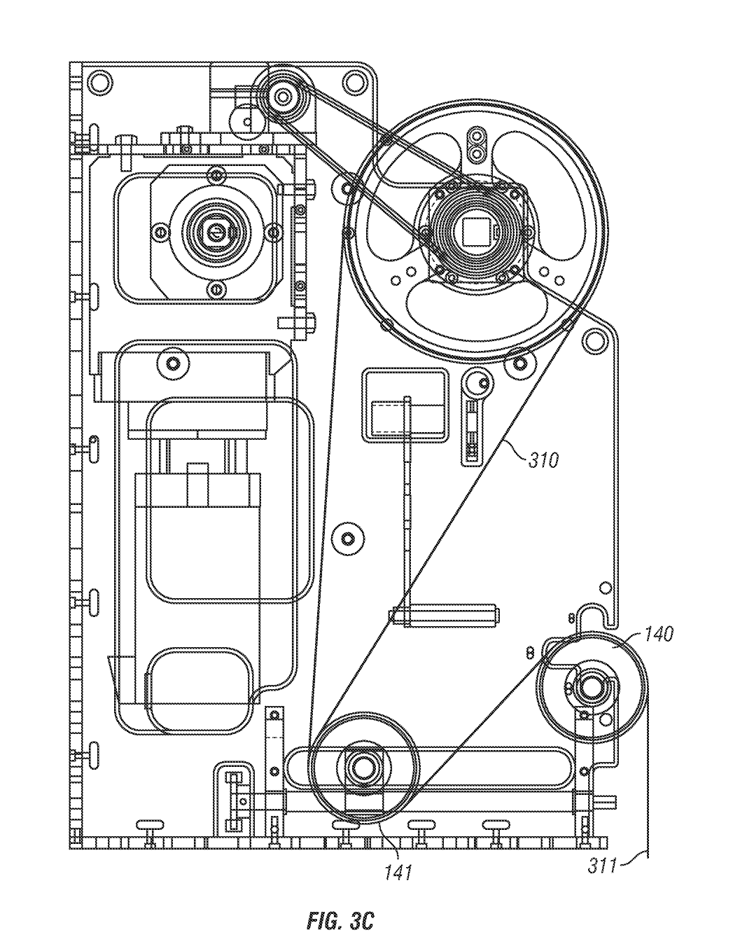

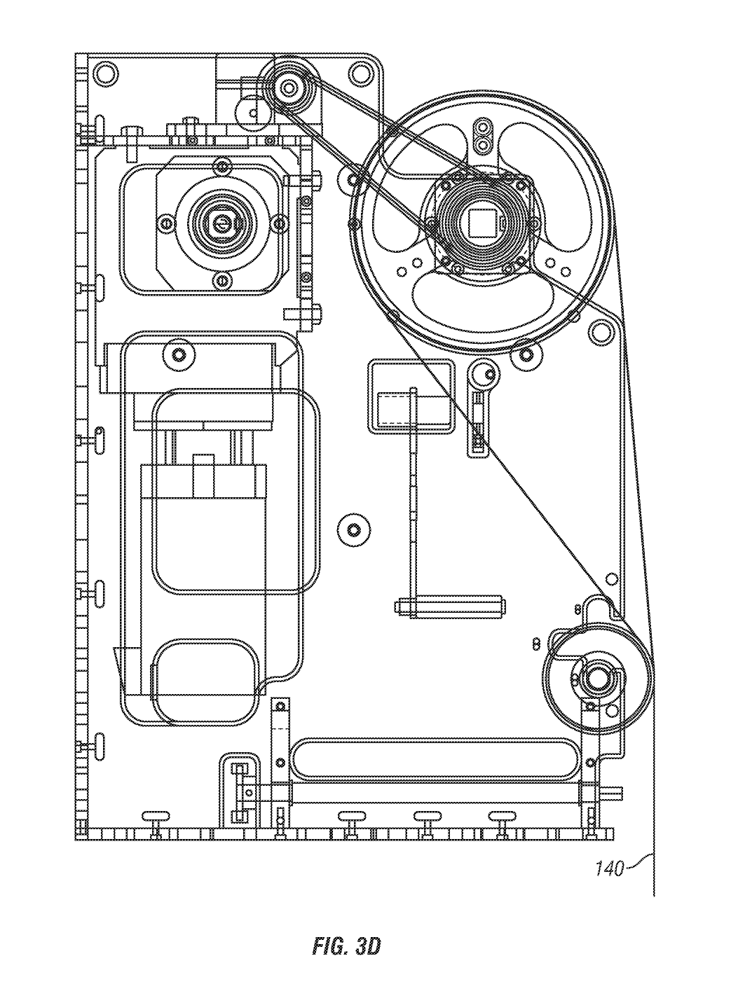

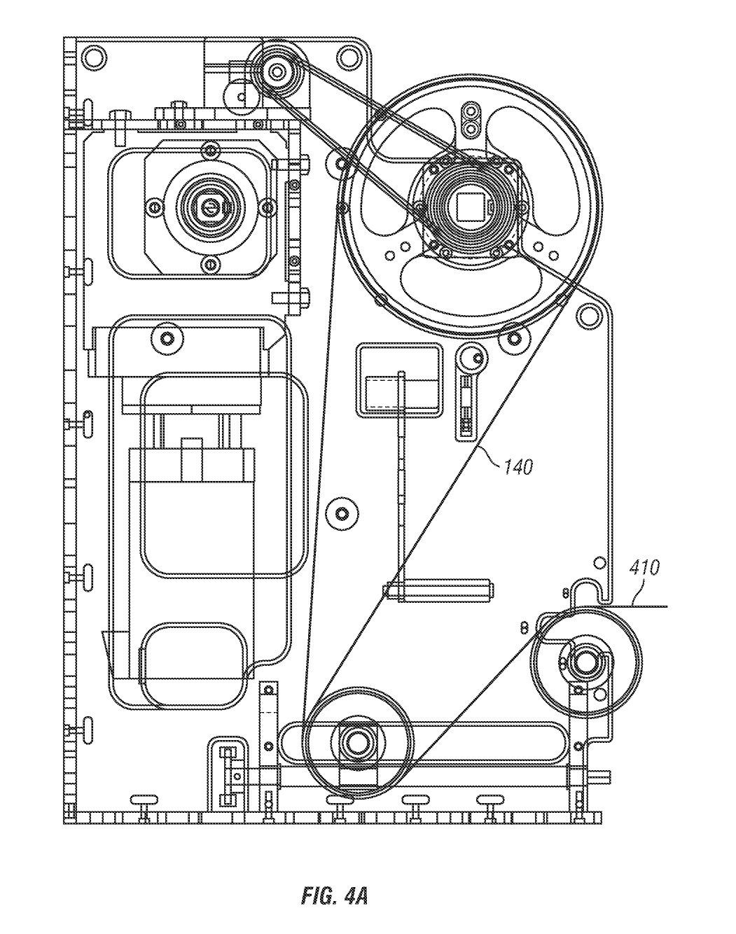

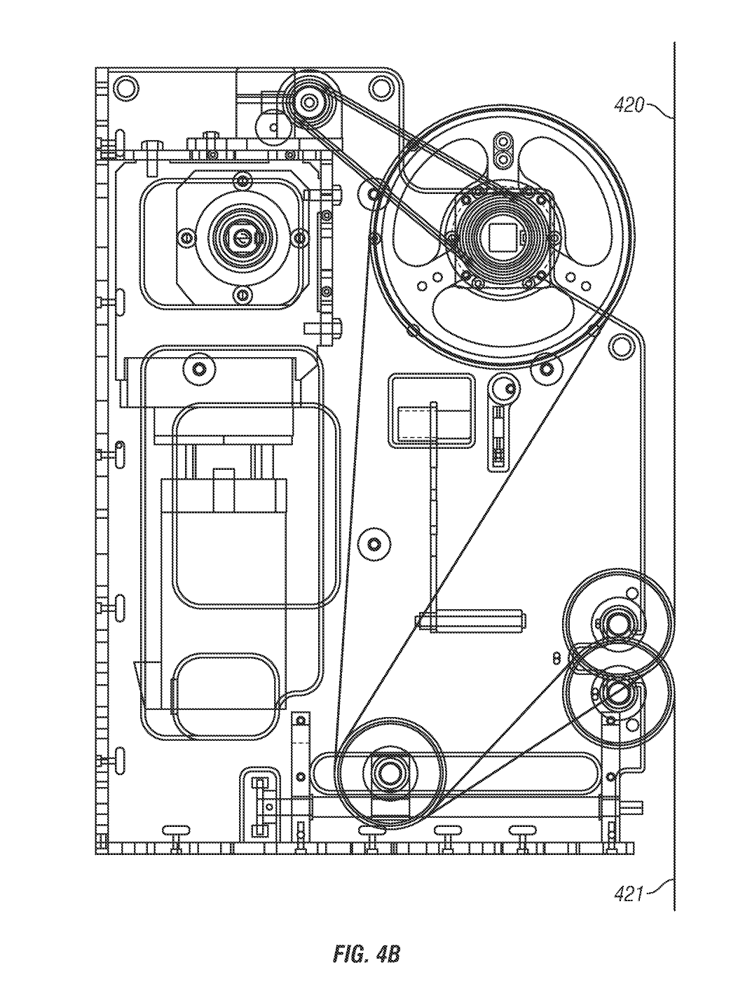

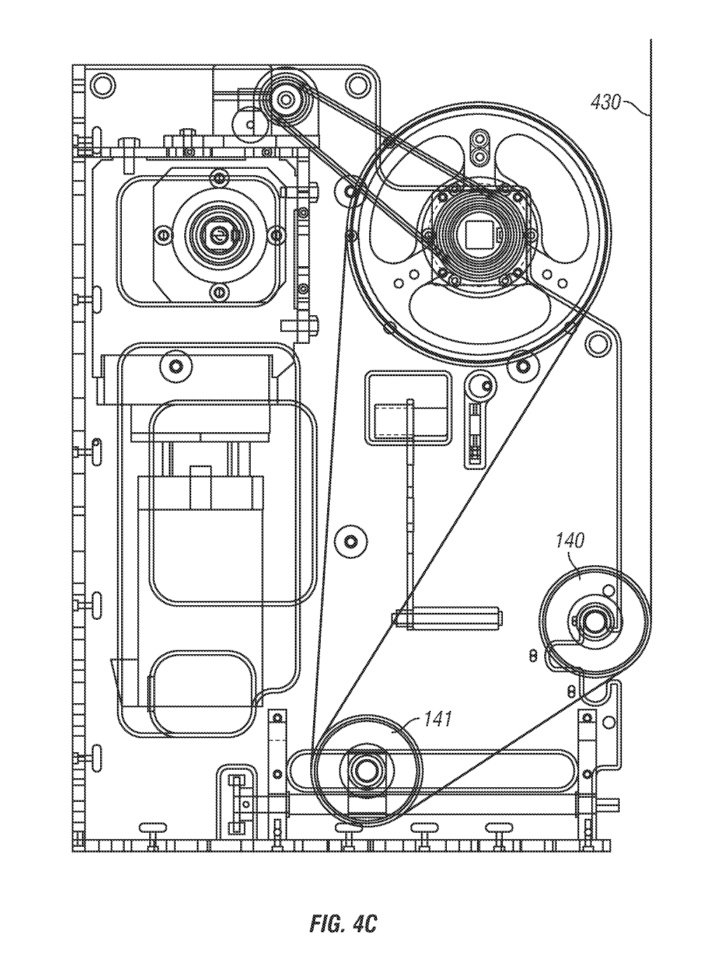

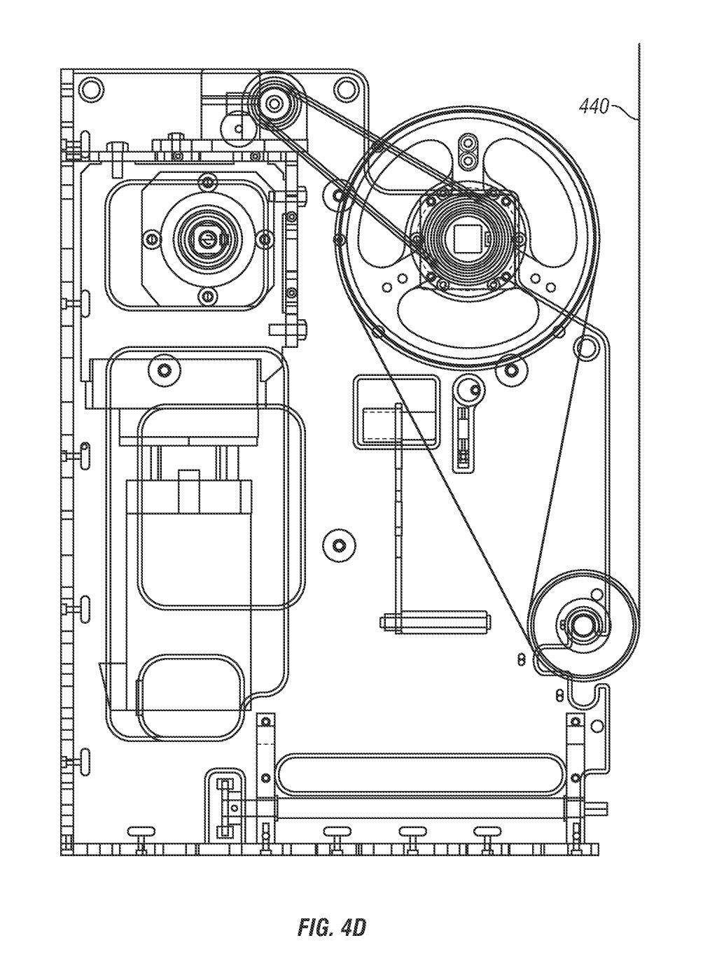

One advantage of this device is the large number of configurations in which it can be used. FIGS. 3A-4B show a number of these different configurations. In each of these figures, the cable “cassette” 99 has been removed so that the path of the different cables can be more easily seen.

In a first configuration shown in FIG. 3A, the cable 301 travels around the drum 120 then at 302 around a second side of the outrigger sheave 140, past the tensioning sheave 141. The cable finally emerges from the right side relative to the figure as 301. This uses two different sheaves, with the outrigger sheave mounted in the central most location 151 and the tensioning sheave mounted as conventional.

FIG. 3B shows use of a single sheave, where the cable 305 travels only around the tensioner sheave 141, and no outrigger sheave at all is provided. The cables still emerges in the same location as in FIG. 3B as 306, but this time without an outrigger sheave.

FIG. 3c also shows use of two sheaves, with the cable 310 traveling around the tensioner sheave 141 first then traveling around the outrigger sheave 140 finally emerging as 311 facing down in the direction of the figure. FIG. 3D shows the cable being wound around only the single outrigger sheave 140. In this embodiment, the outrigger sheave is in the bottom shift holding location.

FIG. 4A shows a configuration where the cable 401 travels around the tensioning sheave, 141 then around the outrigger sheave, and emerges at the side of the winch shown as 410. FIG. 4B shows a three sheave assembly, where the cable which uses dual cables, one cable emerging in the upper direction as 420 and the other going in the downward direction as 421. In this embodiment, there are two sheaves in the top and bottom holders. FIG. 4C shows cable going around the one tensioning sheave 141 then pass the outrigger sheave and emerging upward. FIG. 4C shows the cable emerging upward as 430. FIG. 4D shows the cable also going upward as 440 with only the single outrigger sheave being used.

More generally, the sheaves can be either inside the winch or stick out as needed. Whe shaft detents into notches depending on which way the cable is pulling on the sheaves.

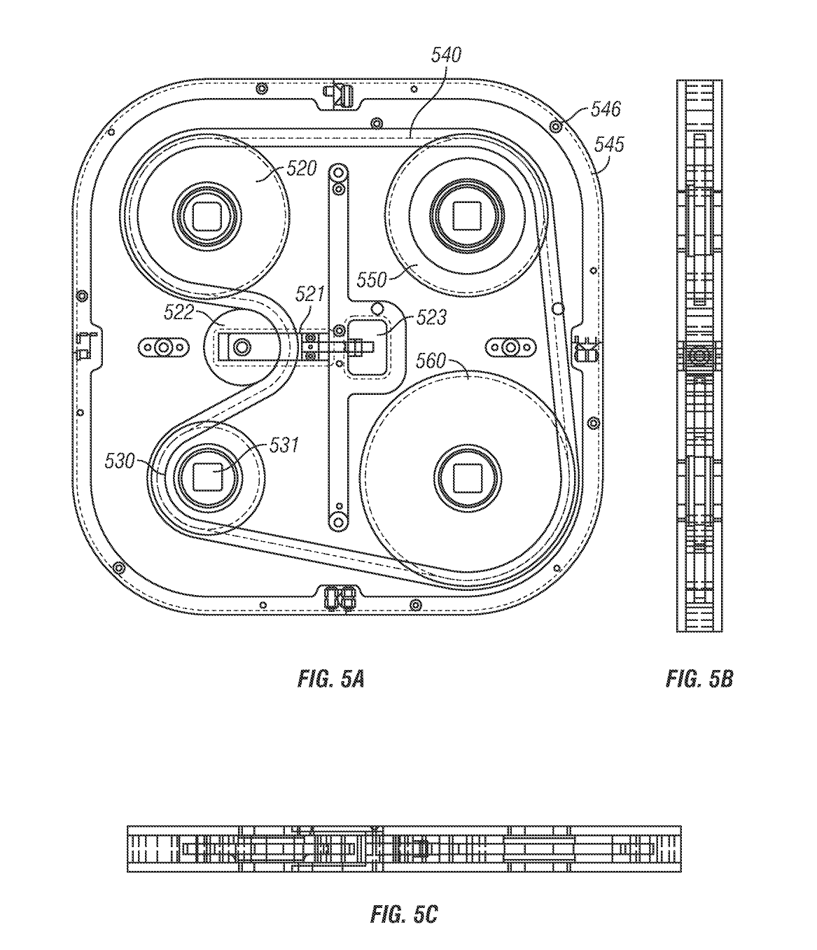

The chain drive assembly shown as 99 in FIG. 1, and is shown in more detail in FIGS. 5A, 5B and 5C. FIG. 5A shows the front on view of the chain drive cassette. The cassette has for different rollers 520, 530, 550 and 560. Each of the rollers is connected by the chain 540. The roller 530 receives the power from the gearbox of the motor assembly attaches to the driven element 530, based on the attachment to the motor gear assembly. This can be connected, for example, using a square shaft placed through the shaft hole 531 and correspondingly placed into the motors gear assembly 115. This drives the chain 540 that extends past the tensioner assembly 521 which has a pulley wheel 522 attached to a tensioning connector 523 that can be selectively tightened and loosened to extend the pulley wheel to tighten or loosen the chain. The chain itself can be number 60 roller link chain 104 links, and in the embodiment the roller chain is 78.75 inches long.

FIG. 5A illustrates how the cassette unit 99 includes a perimeter area 545 with a number of mounting holes 546. This enables the cassette to be quickly mounted and replaced on the winch unit. The cassette is mounted towards an outer periphery of the device so that it can be easily removed and rotated

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example other configurations for other applications are possible.

Also, the inventor intends that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A winch assembly, comprising:
a housing;
a motor, mounted within said housing which is energized to produce rotational force;
a cable holder, mounted within said housing, holding cable which is extended and retracted by rotating said cable holder;
a configurable cassette, which is coupled between said motor and said cable holder to couple said rotational force from said motor to said cable holder, and said cassette having a plurality of different rotatable parts which are connected together such that rotation of any of said rotatable parts causes rotation of others of the rotatable parts, and where said rotatable parts have different characteristics, and where any of said rotatable parts is connectable to said motor to receive the rotational force from said motor, and any of said rotatable parts is connectable to said cable holder, and connecting a first of said rotatable parts to said motor causes a first speed of rotation of said cable holder, and connecting a second of said rotatable parts to said motor causes a second speed of rotation of said cable holder, where said second speed of rotation is different than said first speed of rotation.

2. The assembly as in claim 1, wherein there are four different rotatable parts in said cassette which are connected together, and all of said rotatable parts creates a different speed of rotation.

3. The assembly as in claim 2, further comprising a chain drive extending between said rotatable parts.

4. The assembly as in claim 3, wherein said rotatable parts are roller chain sprockets.

5. The assembly as in claim 1, further comprising at least one sheave assembly, that changes a direction of said cable.

6. The assembly as in claim 1, wherein said cassette includes a chain tensioning part therein which increases or decreases a tension on said chain.

7. The assembly as in claim 5, wherein said sheave assembly includes a walking sheave.

8. The assembly as in claim 5, further comprising first, second and third mounting options for said sheave assembly, each in different locations.

9. The winch assembly as in claim 2, wherein said rotational parts each have connections which can connect to said motor on two different sides of said rotational part, and at least one of said different sides of said rotational part is geared in a different way than an other side of said rotational part thereby allowing two different speeds by connecting to two different sides of the rotational part.

10. A method of driving a winch assembly, comprising:
using a motor for producing a rotational force in a housing at a first location;
in a second location in the housing, rotatably mounting a cable holding assembly that rotates to hold and/or remove cable;
coupling the rotational force from the motor to the cable holding assembly using a configurable device which is coupled between said motor and said cable holding assembly to couple said rotational force from said motor to said cable holder;
operating the configurable device in a first connection where a first rotational part of the configurable device is attached to said motor; and
operating the configurable device in a second connection where a second rotational part of the configurable device is attached to said motor and where said cable assembly rotates at a different speed with said second rotational part connected to said motor than it does with said first rotational part connected to said motor.

11. A method as in claim 10, further comprising operating the configurable device in a third orientation where a second side of the second rotational part is attached to said motor, and where said cable assembly rotates at a first speed with a first side of said second rotational part connected to said motor, and said cable assembly rotates at a second speed different than said first speed with said second side of said second rotational part connected to said motor.

12. A method as in claim 10, wherein there are four different rotatable parts in said configurable device which are connected together to rotate synced to one another, and all of said rotatable parts create a different speed of rotation.

13. A method as in claim 12, further comprising a chain drive extending between said rotatable parts, said chain drive including a chain.

14. A method as in claim 13, wherein said rotatable parts include roller chain sprockets.

15. A method as in claim 11, further comprising changing a direction of output of the cable using at least one sheave assembly.

16. A method as in claim 13, wherein said configurable device includes a chain tensioning part therein which increases or decreases a tension on said chain.

17. A method as in claim 15, further comprising first, second and third mounting options for said sheave assembly, each in different locations.

18. A reconfigurable device for a motorized assembly, comprising:
a housing; and
a drive device, including first, second, third and fourth rotatable parts, and a drive connector between said first, second, third and fourth rotatable parts to couple rotational force applied to any of said first, second, third and fourth rotatable parts to all others of said first, second, third and fourth rotatable parts, and where said rotatable parts have different characteristics such that applying said rotational force as a drive to any of said first, second, third and fourth rotatable parts provides different drive amounts to the others of said first, second, third and fourth rotatable parts,
where each of said first, second, third and fourth rotatable parts have a common format connection.

19. A device as in claim 18, wherein said first, second, third and fourth rotatable parts each have connections on both first and second sides thereof, and where for at least plural of said rotatable parts, a connection on said first side provides a different drive amount than a connection on said second side.

20. An device as in claim 18, wherein said different drive amounts includes a different speed of rotation.

21. An assembly as in claim 18, further comprising a chain drive extending between said first, second, third and fourth rotatable parts.

22. An assembly as in claim 21, wherein said first, second, third and fourth rotatable parts include roller chain sprockets.

23. A device as in claim 21, further comprising a chain tensioning part therein which increases or decreases a tension on said chain drive.
